(19) United States
(12) Patent Application Publication
(10) Pub. No.: US 2016/0292747 A1
(43) Pub. Date: Oct. 6, 2016

(54) METHOD AND APPARATUS FOR PLACING DISPLAY INFORMATION

(71) Applicant: TENCENT TECHNOLOGY (SHENZHEN) COMPANY LIMITED, Shenzhen (CN)

(72) Inventor: Minghao Xi, Shenzhen (CN)

(21) Appl. No.: 15/177,521

(22) Filed: Jun. 9, 2016

Related U.S. Application Data
(63) Continuation of application No. PCT/CN2015/073977, filed on Mar. 11, 2015.

(30) Foreign Application Priority Data
Mar. 12, 2014 (CN) 201410089600.X

(51) Int. Cl. G06Q 30/02; G06F 3/0481

(52) U.S. Cl. CPC G06Q 30/0276; G06F 3/0481

(57) ABSTRACT

The present disclosure discloses a method and an apparatus for placing display information, and belongs to the field of Internet technologies. The method includes: acquiring attribute information of a preset attribute item of a target account; determining, according to a pre-stored correspondence between attribute information and display information pools, a display information pool corresponding to the acquired attribute information, where in the correspondence, directional information of each piece of display information in any one display information pool includes directional information not contradicting attribute information corresponding to the any one display information pool; and placing display information to the target account according to the determined display information pool, and the attribute information of the target account. By using the present disclosure, utilization of display position resources can be improved.

### CROSS REFERENCE TO RELATED APPLICATIONS

This is a continuation application of International Patent Application No. PCT/CN2015/073977, filed on Mar. 11, 2015, which claims priority to Chinese Patent Application No. 201410089600.X filed on Mar. 12, 2014, the disclosures of which are incorporated by reference herein in their entirety.

### FIELD OF THE TECHNOLOGY

The present disclosure relates to the field of Internet technologies, and in particular, to a method and an apparatus for placing display information.

### BACKGROUND OF THE DISCLOSURE

Cost Per Click (CPC) is a manner in which an operator of a network platform (such as a website, or a network application) charges a provider of display information according to a click rate of the display information in the network platform. The display information may include videos, pictures, words, and the like. As the amount of display information grows increasingly, the amount of display information in a display platform is usually far greater than the number of display positions that can be provided by the display platform. In this way, a mechanism needs to be set for a server of the display platform to rationally arrange placement of the display information in the display position.

Generally, for a case in which multiple pieces of display information are displayed on a same display position, a server may first calculate Effective Cost Per Mille (ECPM) of each piece of display information, where the ECPM may be obtained by multiplying cost per click of the display information and the number of clicks (which may be an empirical value or a historical average value) generated by per thousand of displays. Then, the server may sequence the display information according to the ECPM, and select a specified number (such as 1000) of pieces of display information ranked in the most front, to form a display information pool. To improve the placement efficiency, when display information is placed, to-be-placed display information can only be selected in the display information pool, but does not need to be selected in all display information. When display information needs to be placed to a target account, the server acquires attribute information (such as geographical position, gender, or age) of the target account, and selects, from the display information pool, display information whose directional information does not contradict the attribute information, to place the display information, where the directional information is placement direction information specified for the display information by a provider of the display information. For example, if directional information of display information is Shanghai, the server only places the display information to an account whose geographical position attribute is Shanghai. A terminal that logs in to the target account receives the display information and displays the display information.

A part of display information whose ECPM values are high is selected to form a display information pool, and in a display information placement process, it often occurs that the attribute information of the target account contradicts directional information of all display information in the display information pool. For example, geographical position information of the target account is Shanghai, but directional information of all display information in the display information pool is another city (such as Guangzhou, Beijing, or Shenzhen) except Shanghai. When the directional information of all display information in the display information pool contradicts the attribute information of the target account, the server cannot select, from the display information pool, display information to be placed to the target account, but can only place default display information to the target account. For example, one random picture is used as display information to be placed to the target account. In this way, display position resources are wasted.

### SUMMARY

To solve the problem in the existing technology, embodiments of the present invention provide a method and an apparatus for placing display information. The technical solutions are as follows:

According to a first aspect, an embodiment of the present invention provides a method for placing display information, including:

acquiring attribute information of a preset attribute item of a target account;

determining, according to a pre-stored correspondence between attribute information and display information pools, a display information pool corresponding to the acquired attribute information, in the correspondence, directional information of each piece of display information of any one display information pool including directional information not contradicting attribute information corresponding to the any one display information pool; and

placing display information to the target account according to the determined display information pool, and the attribute information of the target account.

According to a second aspect, an embodiment of the present invention provides an apparatus for placing display information, including:

an acquiring module, configured to acquire attribute information of a preset attribute item of a target account;

a determining module, configured to determine, according to a pre-stored correspondence between attribute information and display information pools, a display information pool corresponding to the acquired attribute information, in the correspondence, directional information of each piece of display information of any one display information pool including directional information not contradicting attribute information corresponding to the any one display information pool; and

a placing module, configured to place display information to the target account according to the determined display information pool, and the attribute information of the target account.

In the embodiments of the present invention, attribute information of a preset attribute item of a target account is acquired, a display information pool corresponding to the acquired attribute information is determined according to a pre-stored correspondence between attribute information and display information pools, and display information is placed to the target account based on the determined display information pool, and the attribute information of the target account. In this way, a corresponding display information pool may be set for different attribute information, where the display information pool includes display information whose directional information does not contradict corresponding attribute information, so that the probability of occurrence of a case in which directional information of all display information in the display information pool contradicts the attribute information of the target account is reduced, thereby improving utilization of display position resources.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method for placing display information according to an embodiment of the present invention;

FIG. 2 is a flowchart of a method for placing display information according to an embodiment of the present invention;

FIG. 3 is a flowchart of a method for placing display information according to an embodiment of the present invention;

FIG. 4 is a schematic structural diagram of an apparatus for placing display information according to an embodiment of the present invention; and

FIG. 5 is a schematic structural diagram of a server according to an embodiment of the present invention.

### DESCRIPTION OF EMBODIMENTS

In order to make the technical solutions and advantages of the present disclosure clearer, implementation manners of the present disclosure are further described below in detail with reference to the accompanying drawings.

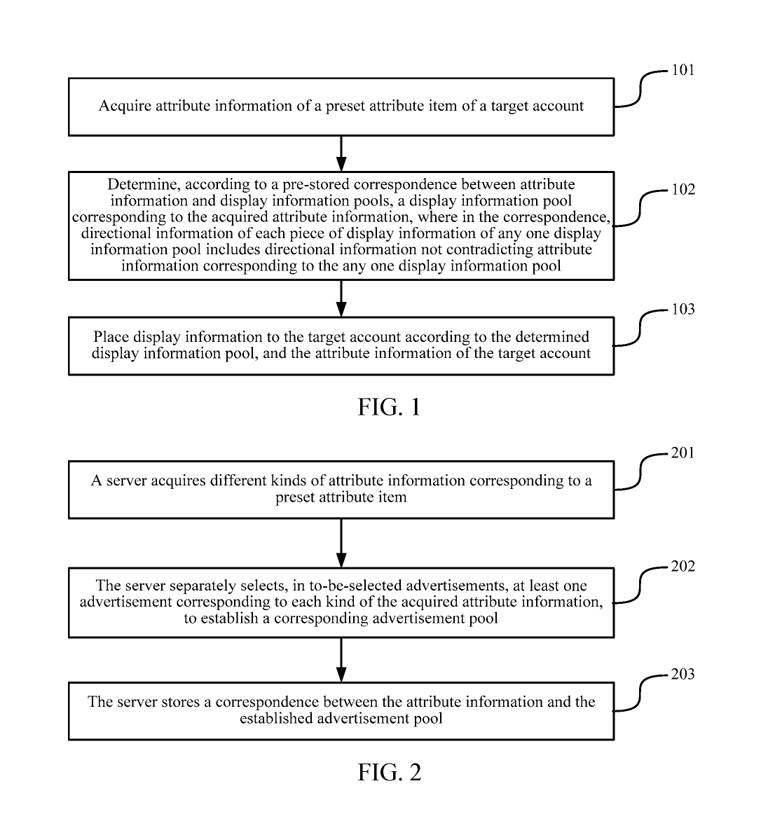

An embodiment of the present invention provides a method for placing display information. As shown in FIG. 1, the method may include the following steps:

Step 101: Acquire attribute information of a preset attribute item of a target account.

Step 102: Determine, according to a pre-stored correspondence between attribute information and display information pools, a display information pool corresponding to the acquired attribute information, where in the correspondence, directional information of each piece of display information of any one display information pool includes directional information not contradicting attribute information corresponding to the any one display information pool.

Step 103: Place display information to the target account according to the determined display information pool, and the attribute information of the target account.

In this embodiment of the present invention, attribute information of a preset attribute item of a target account is acquired, a display information pool corresponding to the acquired attribute information is determined according to a pre-stored correspondence between attribute information and display information pools, and display information is placed to the target account based on the determined display information pool, and the attribute information of the target account. In this way, a corresponding display information pool may be set for different attribute information, where the display information pool includes display information whose directional information does not contradict corresponding attribute information, so that the probability of occurrence of a case in which directional information of all display information in the display information pool contradicts the attribute information of the target account is reduced, thereby improving utilization of display position resources.

An embodiment of the present invention further provides a method for placing display information, where the method is executed by a server of a network service.

In the method, the server may establish multiple display information pools in advance, which are separately corresponding to different attribute information, and may pre-store a correspondence between the attribute information and the display information pools. There may be various processing manners for the server to establish the display information pools, and a preferable processing manner is given below. The process may include the following step 1 to step 3:

Step 1: A server acquires different kinds of attribute information corresponding to a preset attribute item.

The attribute information is user related information that is recorded in an account and is corresponding to the account, and the attribute item is an item of the attribute information, such as geographical position, gender, or age. Each account may include attribute information of one or more attribute items. Each attribute item may be corresponding to one or more kinds of attribute information, for example, different kinds of attribute information corresponding to an attribute item of geographical position may include Shanghai, Beijing, Guangzhou, Shenzhen, and the like; and different kinds of attribute information corresponding to an attribute item of gender may include male and female. In the different kinds of the acquired attribute information, each kind of attribute information may be single attribute information, such as Shanghai, and may also be a combination of attribute information of different preset attribute items, such as Shanghai+male.

During implementation, the server may determine a preset attribute item according to an attribute item corresponding to directional information of each piece of to-be-selected display information (all optional display information that has been provided in a display position). Specifically, the server may acquire the attribute item corresponding to the directional information of each piece of to-be-selected display information. In the acquired attribute items, several attribute items that appear most frequently are selected to be preset attribute items. For example, in 5000 pieces of to-be-selected display information, attribute items corresponding to directional information of 2500 pieces of display information are geographical position, attribute items corresponding to directional information of 2100 pieces of display information are gender, and attribute items corresponding to directional information of the remaining 400 pieces of display information are other items except geographical position and gender. Two attribute items, geographical position and gender that appear most frequently, may be used as preset attribute items.

When acquiring different kinds of attribute information corresponding to the preset attribute item, the server may determine, according to the preset attribute item, all attribute information corresponding to the preset attribute item. For example, if only one attribute item is set, the attribute item is geographical position. If an example that the geographical position being a city where the user is located is used, all attribute information of the preset attribute item may include all cities in the whole country, such as Beijing, Shanghai, Shenzhen, Xianning, and the like. If multiple preset attribute items are included, each kind of attribute information corresponding to the multiple preset attribute items may be a combination of attribute information of different preset attribute items. For example, if the preset attribute items are geographical position and gender, the attribute information acquired by the server may include Beijing+male, Beijing+female, Shanghai+male, Shanghai+female, Shenzhen+male, Shenzhen+female, or the like.

Step: The server separately selects, in to-be-selected display information, at least one piece of display information corresponding to each kind of the acquired attribute information, to establish a corresponding display information pool.

The attribute information corresponding to the at least one piece of display information does not contradict directional information of the at least one piece of display information. The directional information is placement direction information specified for the display information by a provider of the display information, the directional information may be set for each piece of display information, and each piece of directional information has a corresponding attribute item. For example, if the directional information is Shanghai, the corresponding attribute item is geographical position. The to-be-selected display information may be all optional display information that has been provided in a display position. That the directional information contradicts the attribute information refers to that the attribute information includes attribute information of an attribute item corresponding to the directional information, and the attribute information of the attribute item is different from the directional information, for example, if the attribute information includes a geographical position attribute Shanghai, and the directional information is Guangzhou, the directional information contradicts the attribute information. That the directional information does not contradict the attribute information refers to that the attribute information includes the directional information, or the attribute information does not include attribute information of an attribute item corresponding to the directional information, for example, if the attribute information includes a geographical position attribute Shanghai, and the directional information is Shanghai, the directional information does not contradict the attribute information, or, the directional information is not a specified geographical position attribute, for example, if the directional information is male, the directional information does not contradict the attribute information.

During implementation, for a kind of attribute information, the server may acquire, in the to-be-selected display information, all display information whose directional information is included in the attribute information, and acquire all display information in which attribute items corresponding to the directional information are not included in the attribute information, to establish a corresponding display information pool. For example, if the attribute information is Shanghai, all display information whose directional information is Shanghai may be acquired, and all display information in which the geographical position attribute of the directional information is not specified may be acquired.

Preferably, because the amount of the to-be-selected display information is generally large, the amount of multiple pieces of display information that is corresponding to the same attribute information and obtained by the server may also be large. Therefore, when establishing a display information pool, the server may limit the amount of display information in the display information pool. Correspondingly, a processing process of step 2 may be: The server separately selects, in the to-be-selected display information according to an upper limit of the amount of display information in the preset display information pool, at least one piece of display information corresponding to each kind of the acquired attribute information, to establish a corresponding display information pool.

The upper limit of the amount of display information is the maximum amount of display information that can be contained in the display information pool set by the server. For example, if the upper limit of the amount of display information is 1000, the display information pool may only include display information whose amount is less than or equal to 1000.

During implementation, for some attribute information, if the amount of the selected display information that conforms to the condition (the directional information does not contradict the attribute information) is less than or equal to the upper limit, a display information pool may be established according to all the selected display information. If the amount of the selected display information that conforms to the condition is greater than the upper limit, a part of display information may be selected according to a mechanism, such as random selection, or sequenced selection.

Preferably, a sequenced selection manner may be used, and correspondingly, a processing process of step 2 may be: The server separately selects, in the to-be-selected display information according to the upper limit of the amount of display information in the preset display information pool, and a preset display information sequencing rule, at least one piece of display information corresponding to each kind of the acquired attribute information, to establish a corresponding display information pool.

The display information sequencing rule may be any sequencing rule. For example, the display information may be sequenced based on a parameter corresponding to the display information, where the parameter may be a preset priority, effective cost per display (such as ECPM), or the like.

During implementation, for some attribute information, display information whose directional information does not contradict the attribute information may be selected first, and if the amount of the selected display information exceeds the upper limit, the selected display information is sequenced according to the preset display information sequencing rule, then, display information whose amount is the upper limit and that ranks in the most front is selected to form a display information pool, and finally, the display information pool corresponding to each kind of attribute information in different kinds of attribute information is obtained. For example, if the amount of selected display information corresponding to a kind of attribute information is 1200, and an upper limit of a preset amount of display information is 1000, the server sequences the 1200 pieces of display information according to a preset display information sequencing rule, and selects 1000 pieces of display information ranked in the most front, to form the corresponding display information pool.

Certainly, optionally, the server may also not limit the amount of display information in the display information pool.

Step 3: The server stores a correspondence between the attribute information and the established display information pool.

During implementation, the server may separately store different correspondences between the attribute information and the display information pools for different display positions, and may also use a same correspondence between the attribute information and the display information pool for some different display positions.

The following describes in detail a processing process of display information placement shown in FIG. 1 with reference to specific processing manners, and content may be as follows:

Step 101: A server acquires attribute information of a preset attribute item of a target account.

The target account is an account in which display information needs to be placed, and is a logged account of the server.

During implementation, a user may open a web page or open an application page by using a terminal of the user, the terminal may send a page data request to a server, and the server may send corresponding page data to the terminal after receiving the page data request, and separately perform a process of display information placement on each display position in the page. In the placement process, a logged account of the terminal that sends the page data request, that is, a target account, may be first determined. All attribute information of all accounts may be pre-stored in the server. The server may find attribute information of the target account from all the attribute information, and then, the server may select attribute information of the preset attribute item (such as geographical position) from all attribute information of the target account.

Step 102: The server determines, according to a pre-stored correspondence between attribute information and display information pools, a display information pool corresponding to the acquired attribute information.

In the correspondence, directional information of each piece of display information of any one display information pool includes directional information not contradicting attribute information corresponding to the any one display information pool. Preferably, the display information pool may only include display information whose directional information does not contradict the attribute information corresponding to the display information pool. Certainly, optionally, the display information pool may also include display information whose directional information contradicts the attribute information corresponding to the display information pool.

During implementation, the attribute information acquired in step 101 may be used to query the stored correspondence between the attribute information and the display information pools, to obtain a corresponding display information pool.

Step 103: The server places display information to the target account according to the determined display information pool, and the attribute information of the target account.

Specifically, there may be various processing manners for the server to place the display information to the target account, and a preferable processing manner is given below. Correspondingly, a processing process of step 103 may include the following steps:

Step 1: The server selects, in the determined display information pool according to the attribute information of the target account, display information whose directional information does not contradict the attribute information of the target account.

During implementation, the attribute information of the target account used in the step not only is attribute information of a preset attribute item, but also may be all attribute information of the target account. The server compares the directional information of each piece of display information in the determined display information pool with all attribute information corresponding to the target account, determines whether the directional information contradicts the attribute information, and selects display information whose directional information does not contradict the attribute information of the target account.

Step 2: The server places the display information to the target account according to the selected display information.

Specifically, the server may place the selected display information to the target account in turn according to a preset placement period.

During implementation, the display information selected in step 1 may be first sequenced according to the display information sequencing rule, and then placement may be arranged in the sequenced order. During the placement, the server may preset a placement period, and first send display information ranked in the first to a logged terminal (that is, the terminal that sends the page data request) of the target account, the terminal displays the display information in a display position corresponding to a page, and when the placement period is due, the server then sends display information ranked in the second to the terminal to replace the previous display information for display, and the rest may be deduced by analogy, until the user closes the page.

In addition, the server may further select an amount (such as 10 pieces) of display information from the determined display information pool to place the display information to the target account. For example, the most front 10 pieces of display information may be selected, according to the sequence, for placement. When receiving the amount of display information, the terminal displays the display information in turn according to the sequence of the display information.

In this embodiment of the present invention, attribute information of a preset attribute item of a target account is acquired, a display information pool corresponding to the acquired attribute information is determined according to a pre-stored correspondence between attribute information and display information pools, and display information is placed to the target account based on the determined display information pool, and the attribute information of the target account. In this way, a corresponding display information pool may be set for different attribute information, where the display information pool includes display information whose directional information does not contradict corresponding attribute information, so that the probability of occurrence of a case in which directional information of all display information in the display information pool contradicts the attribute information of the target account is reduced, thereby improving utilization of display position resources.

The following describes in detail the method for placing display information provided in this embodiment of the present invention with reference to an application scenario of advertisement placement.

In the application scenario, the display information is an advertisement, the display information pool is an advertisement pool, the display position is an advertisement position, the server may be a server of a website, an advertisement position may be set in a web page of the website, and the target account may be an account used when a user logs in to the website.

In the application scenario, a processing process for the server to establish an advertisement pool corresponding to multiple kinds of attribute information may, as shown in FIG. 2, include the following steps:

Step 201: A server acquires different kinds of attribute information corresponding to a preset attribute item.

Step 202: The server separately selects, in to-be-selected advertisements, at least one advertisement corresponding to each kind of the acquired attribute information, to establish a corresponding advertisement pool.

The attribute information corresponding to the at least one advertisement does not contradict directional information of the at least one advertisement.

Preferably, the processing process of step 202 may be: The server separately selects, in the to-be-selected advertisement according to an upper limit of the number of advertisements in the preset advertisement pool, and a preset advertisement sequencing rule, at least one advertisement corresponding to each kind of the acquired attribute information, to establish a corresponding advertisement pool.

Preferably, the advertisement sequencing rule may be sequencing the advertisements according to ECPM in a descending order.

Step 203: The server stores a correspondence between the attribute information and the established advertisement pool.

For specific processing manners of the foregoing steps, reference may be made to related content of Embodiment 2, which are not described again herein.

In the application scenario, a user performs an operation on a terminal of the user and opens the web page on which an advertisement position is set. The terminal may send a page data request to the server, and the server sends page data of the web page to the terminal. In addition, a process of placing an advertisement to each advertisement position and a process for the server to place an advertisement may, as shown in FIG. 3, include the following steps:

Step 301: A server acquires attribute information of a preset attribute item of a target account.

Step 302: The server determines, according to a pre-stored correspondence between attribute information and advertisement pools, an advertisement pool corresponding to the acquired attribute information.

In the correspondence, directional information of each advertisement of any one advertisement pool includes directional information not contradicting attribute information corresponding to the any one advertisement pool.

Step 303: The server selects, in the determined advertisement pool according to the attribute information of the target account, an advertisement whose directional information does not contradict the attribute information of the target account.

Step 304: The server places the advertisement to the target account according to the selected advertisement.

Preferably, for selected advertisements, the server may sequence the selected advertisements according to an ECPM value of each advertisement. During the placement, the server may preset a placement period, and send a selected advertisement to a logged terminal of the target account according to the placement period of the advertisements and in an order after the advertisements are sequenced, so that the terminal periodically displays the advertisements in turn at an advertisement position corresponding to the web page.

For specific processing manners of the foregoing steps, reference may be made to related content of Embodiment 2, which are not described again herein.

In a conventional technology, for a case in which a large number of to-be-selected advertisements are on a same advertisement position, a general manner is: A server first calculates an ECPM value of each advertisement in multiple to-be-selected advertisements, and then, the server sequences the advertisements according to the ECPM values in a descending order, and selects a specified number of advertisements ranked in the most front, to form an advertisement pool (that is, only constructing one advertisement pool). When placing an advertisement, the server only selects, from the advertisement pool, an advertisement whose directional information does not contradict the attribute information of the target account to place the advertisement. In the foregoing processing manner of the conventional technology, it may often occur that the directional information of all advertisements in the advertisement pool contradicts the attribute information of the target account.

However, in the advertisement placement manner of this embodiment of the present invention, advertisement pools are separately set in multiple kinds of attribute information corresponding to a preset attribute item. During advertisement placement, attribute information of the preset attribute item of the target account is acquired, an advertisement pool corresponding to the acquired attribute information is determined according to a pre-stored correspondence between attribute information and advertisement pools, and advertisements are placed to the target account based on the determined advertisement pool, and the attribute information of the target account. In this way, for different kinds of attribute information, a corresponding advertisement pool may be selected, where the advertisement pool includes an advertisement whose directional information does not contradict the corresponding attribute information, so that the probability of occurrence of a case in which directional information of all advertisements in the advertisement pool contradicts the attribute information of the target account is reduced, thereby improving utilization of advertisement position resources.

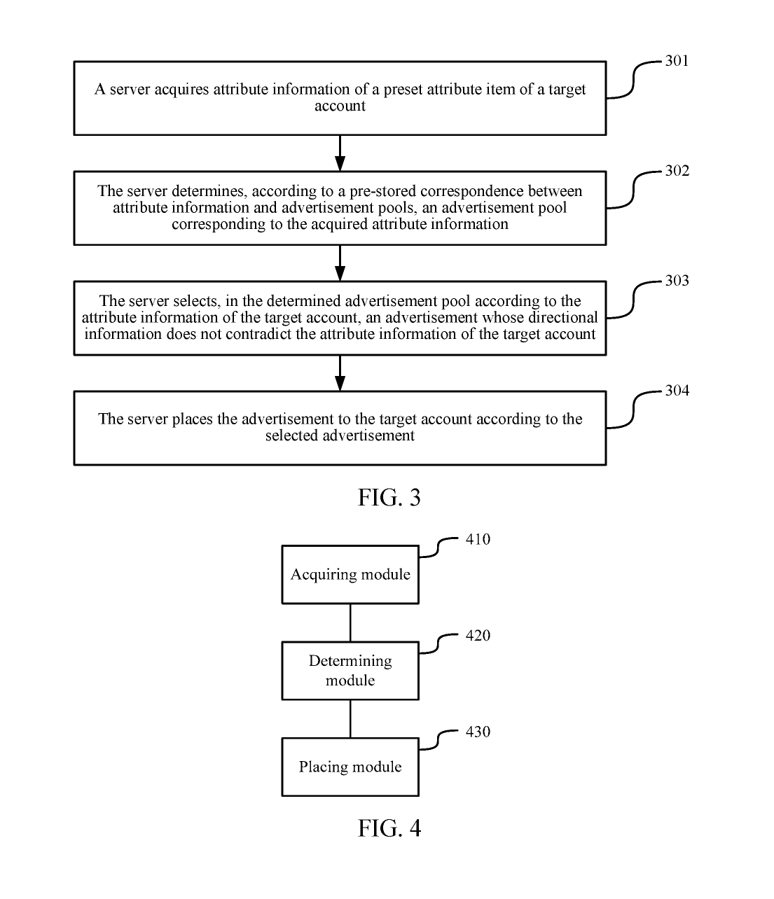

An embodiment of the present invention further provides an apparatus for placing display information. As shown in FIG. 4, the apparatus includes:

an acquiring module 410, configured to acquire attribute information of a preset attribute item of a target account;

a determining module 420, configured to determine, according to a pre-stored correspondence between attribute information and display information pools, a display information pool corresponding to the acquired attribute information, where in the correspondence, directional information of each piece of display information of any one display information pool includes directional information not contradicting attribute information corresponding to the any one display information pool; and

a placing module 430, configured to place display information to the target account according to the determined display information pool, and the attribute information of the target account.

Optionally, the apparatus further includes a storing module, configured to:

acquire different kinds of attribute information corresponding to the preset attribute item;

separately select, in to-be-selected display information, at least one piece of display information corresponding to each kind of the acquired attribute information, to establish a corresponding display information pool, where the attribute information corresponding to the at least one piece of display information does not contradict directional information of the at least one piece of display information; and

store a correspondence between the attribute information and the established display information pool.

Optionally, the storing module is configured to:

separately select, in the to-be-selected display information according to an upper limit of the amount of display information in the preset display information pool, at least one piece of display information corresponding to each kind of the acquired attribute information, to establish the corresponding display information pool.

Optionally, the storing module is configured to:

separately select, in the to-be-selected display information according to the upper limit of the amount of display information in the preset display information pool, and a preset display information sequencing rule, at least one piece of display information corresponding to each kind of the acquired attribute information, to establish the corresponding display information pool.

Optionally, the placing module 430 is configured to:

select, in the determined display information pool according to the attribute information of the target account, display information whose directional information does not contradict the attribute information of the target account; and

place the display information to the target account according to the selected display information.

Optionally, the placing module 430 is configured to:

place the selected display information to the target account in turn according to a preset placement period.

In this embodiment of the present invention, attribute information of a preset attribute item of a target account is acquired, a display information pool corresponding to the acquired attribute information is determined according to a pre-stored correspondence between attribute information and display information pools, and display information is placed to the target account based on the determined display information pool, and the attribute information of the target account. In this way, a corresponding display information pool may be set for different attribute information, where the display information pool includes display information whose directional information does not contradict corresponding attribute information, so that the probability of occurrence of a case in which directional information of all display information in the display information pool contradicts the attribute information of the target account is reduced, thereby improving utilization of display position resources.

It should be noted that, when the apparatus for placing display information provided in the foregoing embodiment is placing display information, only division of the foregoing functional modules is described by using an example. In an actual application, the foregoing functions may be allocated, according to requirements, to different functional modules to be completed, that is, an internal structure of the server is divided into different functional modules, to complete all or part of functions described above. In addition, the apparatus for placing display information provided in the foregoing embodiment and the method embodiment for placing display information belong to the same concept, and refer to the method embodiment for details of a specific implementation process, which are not described again herein.

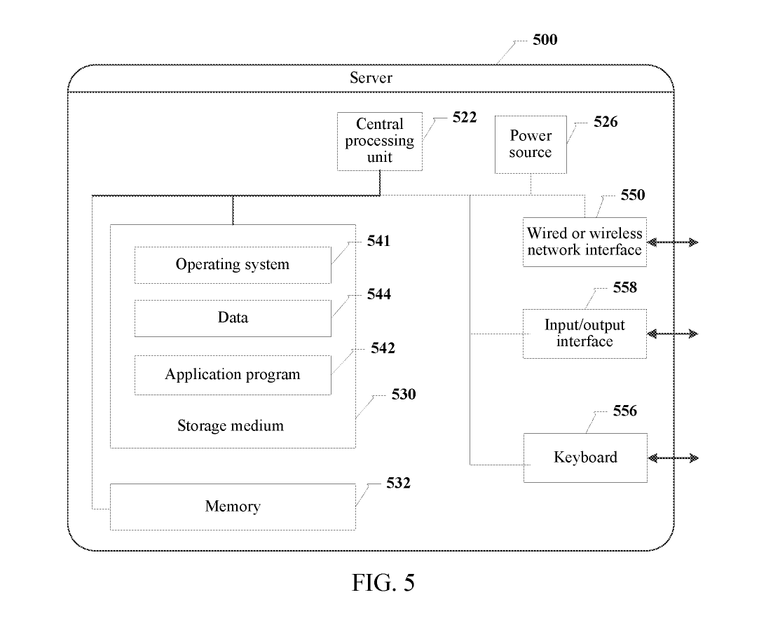

Referring to FIG. 5, FIG. 5 shows a schematic structural diagram of a server according to an embodiment of the present invention. The server may be configured to implement the method for placing display information provided in the foregoing embodiment. Specifically:

The server 500 may differ a lot due to the difference of configuration or performance, and may include one or more central processing units (CPUs) 522 (for example, one or more processors) and a memory 532, and one or more storage media 530 for storing an application program 542 or data 544 (for example, one or more mass storage devices). The memory 532 and the storage media 530 may be transient storage or persistent storage. A program stored in the storage media 530 may include one or more modules (not shown in the figure), and each module may include a series of instructions and operations to the server. Further, the central processing unit 522 may be set to communicate with the storage media 530, and executes the series of instructions and operations in the storage media 530 on the server 500. The server 500 may further include one or more power sources 526, one or more wired or wireless network interfaces 550, one or more input/output interfaces 558, one or more keyboards 556, and/or, one or more operating systems 541, such as Windows Server™, Mac OS X™, Unix™, Linux™, and FreeBSD™. Specifically, in this embodiment, the server includes a memory, and one or more programs, where the one or more programs are stored in the memory, and the one or more programs may include one or more modules, where each module may include a series of instructions and operations to the server. The one or more programs are configured for execution by the one or more processors and include instructions for performing the following operations:

acquiring attribute information of a preset attribute item of a target account;

determining, according to a pre-stored correspondence between attribute information and display information pools, a display information pool corresponding to the acquired attribute information, where in the correspondence, directional information of each piece of display information of any one display information pool includes directional information not contradicting attribute information corresponding to the any one display information pool; and

placing display information to the target account according to the determined display information pool, and the attribute information of the target account.

Optionally, the method further includes:

acquiring different kinds of attribute information corresponding to the preset attribute item;

separately selecting, in to-be-selected display information, at least one piece of display information corresponding to each kind of the acquired attribute information, to establish a corresponding display information pool, where the attribute information corresponding to the at least one piece of display information does not contradict directional information of the at least one piece of display information; and

storing a correspondence between the attribute information and the established display information pool.

Optionally, the separately selecting, in to-be-selected display information, at least one piece of display information corresponding to each kind of the acquired attribute information, to establish a corresponding display information pool includes:

separately selecting, in the to-be-selected display information according to an upper limit of the amount of display information in the preset display information pool, at least one piece of display information corresponding to each kind of the acquired attribute information, to establish the corresponding display information pool.

Optionally, the separately selecting, in the to-be-selected display information according to an upper limit of the amount of display information in the preset display information pool, at least one piece of display information corresponding to each kind of the acquired attribute information, to establish the corresponding display information pool includes:

separately selecting, in the to-be-selected display information according to the upper limit of the amount of display information in the preset display information pool, and a preset display information sequencing rule, at least one piece of display information corresponding to each kind of the acquired attribute information, to establish the corresponding display information pool.

Optionally, the placing display information to the target account according to the determined display information pool, and the attribute information of the target account includes:

selecting, in the determined display information pool according to the attribute information of the target account, display information whose directional information does not contradict the attribute information of the target account; and

placing the display information to the target account according to the selected display information.

Optionally, the placing the display information to the target account according to the selected display information includes:

placing the selected display information to the target account in turn according to a preset placement period.

In this embodiment of the present invention, attribute information of a preset attribute item of a target account is acquired, a display information pool corresponding to the acquired attribute information is determined according to a pre-stored correspondence between attribute information and display information pools, and display information is placed to the target account based on the determined display information pool, and the attribute information of the target account. In this way, a corresponding display information pool may be set for different attribute information, where the display information pool includes display information whose directional information does not contradict corresponding attribute information, so that the probability of occurrence of a case in which directional information of all display information in the display information pool contradicts the attribute information of the target account is reduced, thereby improving utilization of display position resources

A person of ordinary skill in the art may understand that all or some of the steps of the foregoing embodiments may be implemented by using hardware, or may be implemented by a program instructing relevant hardware. The program may be stored in a non-transitory computer readable storage medium. The storage medium may be a read-only memory, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. A method for placing display information, comprising:
acquiring attribute information of a preset attribute item of a target account;
determining, according to a pre-stored correspondence between attribute information and display information pools, a display information pool corresponding to the acquired attribute information, in the correspondence, directional information of each piece of display information of any one display information pool comprising directional information not contradicting attribute information corresponding to the any one display information pool; and
placing display information to the target account according to the determined display information pool, and the attribute information of the target account.

2. The method according to claim 1, wherein the method further comprises:
acquiring different kinds of attribute information corresponding to the preset attribute item;
separately selecting, in to-be-selected display information, at least one piece of display information corresponding to each kind of the acquired attribute information, to establish a corresponding display information pool, wherein the attribute information corresponding to the at least one piece of display information does not contradict directional information of the at least one piece of display information; and
storing a correspondence between the attribute information and the established display information pool.

3. The method according to claim 2, wherein the separately selecting, in to-be-selected display information, at least one piece of display information corresponding to each kind of the acquired attribute information, to establish a corresponding display information pool comprises:
separately selecting, in the to-be-selected display information according to an upper limit of the amount of display information in the preset display information pool, at least one piece of display information corresponding to each kind of the acquired attribute information, to establish the corresponding display information pool.

4. The method according to claim 3, wherein the separately selecting, in the to-be-selected display information according to an upper limit of the amount of display information in the preset display information pool, at least one piece of display information corresponding to each kind of the acquired attribute information, to establish the corresponding display information pool comprises:
separately selecting, in the to-be-selected display information according to the upper limit of the amount of display information in the preset display information pool, and a preset display information sequencing rule, at least one piece of display information corresponding to each kind of the acquired attribute information, to establish the corresponding display information pool.

5. The method according to claim 1, wherein the placing display information to the target account according to the determined display information pool, and the attribute information of the target account comprises:
selecting, in the determined display information pool according to the attribute information of the target account, display information whose directional information does not contradict the attribute information of the target account; and
placing the display information to the target account according to the selected display information.

6. The method according to claim 5, wherein the placing the display information to the target account according to the selected display information comprises:
placing the selected display information to the target account in turn according to a preset placement period.

7. An apparatus for placing display information, comprising:
an acquiring module, configured to acquire attribute information of a preset attribute item of a target account;
a determining module, configured to determine, according to a pre-stored correspondence between attribute information and display information pools, a display information pool corresponding to the acquired attribute information, in the correspondence, directional information of each piece of display information of any one display information pool comprising directional information not contradicting attribute information corresponding to the any one display information pool; and
a placing module, configured to place display information to the target account according to the determined display information pool, and the attribute information of the target account.

8. The apparatus according to claim 7, further comprising a storing module, configured to:
acquire different kinds of attribute information corresponding to the preset attribute item;
separately select, in to-be-selected display information, at least one piece of display information corresponding to each kind of the acquired attribute information, to establish a corresponding display information pool, wherein the attribute information corresponding to the at least one piece of display information does not contradict directional information of the at least one piece of display information; and
store a correspondence between the attribute information and the established display information pool.

9. The apparatus according to claim 8, wherein the storing module is configured to:
separately select, in the to-be-selected display information according to an upper limit of the amount of display information in the preset display information pool, at least one piece of display information corresponding to each kind of the acquired attribute information, to establish the corresponding display information pool.

10. The apparatus according to claim 9, wherein the storing module is configured to:
separately select, in the to-be-selected display information according to the upper limit of the amount of display information in the preset display information pool, and a preset display information sequencing rule, at least one piece of display information corresponding to each kind of the acquired attribute information, to establish the corresponding display information pool.

11. The apparatus according to claim 7, wherein the placing module is configured to:
select, in the determined display information pool according to the attribute information of the target account, display information whose directional information does not contradict the attribute information of the target account; and
place the display information to the target account according to the selected display information.

12. The apparatus according to claim 11, wherein the placing module is configured to:
place the selected display information to the target account in turn according to a preset placement period.

13. An apparatus for placing display information, comprising:
a processor; and
a memory storing instructions executable by the processor to implementing a method for placing display information, wherein the method comprises:
acquiring attribute information of a preset attribute item of a target account;
determining, according to a pre-stored correspondence between attribute information and display information pools, a display information pool corresponding to the acquired attribute information, in the correspondence, directional information of each piece of display information of any one display information pool comprising directional information not contradicting attribute information corresponding to the any one display information pool; and
placing display information to the target account according to the determined display information pool, and the attribute information of the target account.

14. The apparatus according to claim 13, wherein the method further comprises:
acquiring different kinds of attribute information corresponding to the preset attribute item;
separately selecting, in to-be-selected display information, at least one piece of display information corresponding to each kind of the acquired attribute information, to establish a corresponding display information pool, wherein the attribute information corresponding to the at least one piece of display information does not contradict directional information of the at least one piece of display information; and
storing a correspondence between the attribute information and the established display information pool.

15. The apparatus according to claim 14, wherein the separately selecting, in to-be-selected display information, at least one piece of display information corresponding to each kind of the acquired attribute information, to establish a corresponding display information pool comprises:
separately selecting, in the to-be-selected display information according to an upper limit of the amount of display information in the preset display information pool, at least one piece of display information corresponding to each kind of the acquired attribute information, to establish the corresponding display information pool.

16. The apparatus according to claim 15, wherein the separately selecting, in the to-be-selected display information according to an upper limit of the amount of display information in the preset display information pool, at least one piece of display information corresponding to each kind of the acquired attribute information, to establish the corresponding display information pool comprises:
separately selecting, in the to-be-selected display information according to the upper limit of the amount of display information in the preset display information pool, and a preset display information sequencing rule, at least one piece of display information corresponding to each kind of the acquired attribute information, to establish the corresponding display information pool.

17. The apparatus according to claim 13, wherein the placing display information to the target account according to the determined display information pool, and the attribute information of the target account comprises:
selecting, in the determined display information pool according to the attribute information of the target account, display information whose directional information does not contradict the attribute information of the target account; and
placing the display information to the target account according to the selected display information.

18. The apparatus according to claim 17, wherein the placing the display information to the target account according to the selected display information comprises:
placing the selected display information to the target account in turn according to a preset placement period.
